(19) United States
(12) Patent Application Publication
(10) Pub. No.: US 2007/0270135 A1
(43) Pub. Date: Nov. 22, 2007

(54) Method And Device For Selecting A Carrier For Wireless Communication For A Mobile Electronic Online Game Terminal Device

(76) Inventor: Dirk Gaschler, Wermelskirchen (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/568,935

(22) PCT Filed: May 12, 2004
(86) PCT No.: PCT/IB04/01522

§ 371 Date: Feb. 26, 2007

(51) Int. Cl. H04M 11/08; H04L 12/56; H04L 29/06

(52) U.S. Cl. 455/414.3

(57) ABSTRACT

The present invention relates to a method for operating mobile terminal devices and to mobile terminal devices having the capability of communicating via different radio communication connections. The invention relates to the selection of radio transmission channels especially in the field of mobile online gaming. The invention provides a method for selecting a carrier for wireless communication of a mobile electronic terminal device that can execute wireless online game applications by exchanging communication data with at least one remotely located device by using any of a plurality of distinct communication carriers. The method of the invention comprises wirelessly executing an online game application, retrieving a latency time period requirement for the game data transmissions for said executed online game application, determining available communication carriers for wireless communication, determining which of the available communication carriers is appropriate for the intended wireless communication based on latency time requirements of the executed wireless online game application, and selecting at least one of said available and appropriate communication carriers fulfilling said latency time period requirement for bearing the data transfer for said online game.

The present invention relates to mobile terminal devices having the capability of communicating via different radio communication connections. The invention relates to the selection of radio transmission channels especially in the field of mobile online gaming. The present invention relates to user devices that can access services via more than one data transfer connection, e.g. via UMTS and Bluetooth. It also relates to programs and applications executable in a mobile terminal device with a minimized requirement of user interaction. More specifically the invention relates to a simple method of automatically selecting a communication carrier for a game application running on a mobile terminal device, according to actually accessible, available or required latency time periods.

Mobile communication devices of today can access a great number of different communication channels. These channels, are for example, a number of cellular telephone based radio communication links such as GSM, GPRS; HSCSD; WCDMA etc. as well as short range radio links such as Bluetooth; WLAN etc.. All these accessible radio links have different advantages and there are different suggestions which one of these channels is to be preferred.

Future devices will have the ability to access remote services via multiple interfaces, e.g. via UMTS (when travelling), via a short range wireless connection like a wireless LAN or Bluetooth (when not moving fast), or via a wired connection such as Ethernet or the like (when stationary).

As such access technologies have significantly different characteristics, users may wish to change the configurations of applications depending on the access technology currently used. As an example, restricted bandwidths of GSM may be suitable for the use with services that can operate at low data rates, while a Bluetooth connection would permit using the same service at much higher data rates and thereby quality. Furthermore, costs might be different depending on the access technology and users do not want to waste money by using cost-ineffective data connections.

As an example, limited data rates of GSM (<50 kbit/s) may be suitable for the use with services that require low data rates, while a Bluetooth connection (>500 kbit/s) would permit the use of the same service at much higher data rate and thereby quality. Furthermore, the cost of accessing a network might be different depending on the access technology (Bluetooth for free, UMTS maybe costly) and it would be beneficial for the user if the device would be configurable taking into account such differences.

The state of the art provides e.g. a “Method and system for increasing the quality of service at or below a threshold cost” of EP 0 848 560 A2 by Siemens Business Communication systems, which relates to the control of the selection of a data transfer connection in accordance with predetermined threshold cost. In this document the selection of the data transfer connection is executed according to predetermined optimization algorithms, to provide the service with the best transmission quality at a given cost. The document describes an automatic data transmission connection selection, but not a simplification of the access or application parameters of a certain application.

The state of the art also provides document WO 01/35689 A1 by NOKIA NETWORKS OY relating to a “Data transmission method and Network system” that is capable of selecting a data communication carrier according to predetermined data carrier selection parameters.

Both documents fail to describe the adaptation of application configurations according to the selection of a certain data transfer connection.

If the selectable data connection depends on different transfer modes, with different transfer properties, it is desirable to select the connection that fits the performance of the transfer channel and said game application using that channel, to optimize the overall performance.

According to a first aspect of the present invention there is provided a method for selecting a carrier for wireless communication of a mobile electronic terminal device capable of executing wireless online game applications by exchanging communication data with at least one remotely located device by using anyone of a plurality of distinct communication carriers. The method comprises the steps of wirelessly executing an online game application, retrieving a latency time period requirement for the game data transmissions for said executed online game application, determining available communication carriers for wireless communication, determining which of the available communication carriers is appropriate for the intended wireless communication based on latency time requirements of the executed wireless online game application, and selecting at least one of said available and appropriate communication carriers fulfilling said latency time period requirement for bearing the data transfer for said online game. The method can be extended by actually transferring data to execute said online game via said selected carrier.

By executing a wireless online game application on said game terminal, a need arises to exchange data with a game server or another (mobile) gaming device. An aspect resides in that mobile gaming and therefore wireless gaming is enabled.

By receiving or retrieving a latency time period requirement for the execution of said online game application a minimum requirement for a selected data connection is determined.

The aforementioned latency or latency time period or transmission latency time period represents the time period that is required to transfer a user input via an online connection to another terminal device, i.e. the loss of time that is caused by wireless game data transmission. If this time exceeds a certain limit it becomes noticeable by the user which severely decrease the gaming experience.

Thereby a pre-selection of possible appropriate radio communication carriers can be performed e.g. by excluding those communication carriers from the selection that can inherently not provide the demanded latency. The latency time period requirement for the execution of said online game application can be received from the game application itself. It is also possible that the device retrieves this information from the game application. It is also possible that the device or the application retrieves this information from a remote game server or game peer device.

By determining the available communication carriers for wireless communication it can be detected which of the data transfer paths the device can principally use is actually available and may be used for a wireless game data transfer.

By determining which of the available communication carriers is appropriate for the intended wireless communication based on latency time requirements of the executed wireless online game application it is determined which of the communication carriers is actually able to provide an acceptable gaming experience to the user.

By selecting at least one of said appropriate communication carriers which fulfills said latency time period requirement it is always assured that the game application can be executed with a communication latency that enables an enjoyment of the user. By selecting at least one of said appropriate communication carriers it is also possible to select more than one communication carrier e.g. one for the upload direction and one for the download direction. Thereby, a multi-path communication is enabled e.g. for a data exchange with different reception and transmission rates and even different upload and download bandwidths and different latency periods.

A example embodiment of the method of the present invention further comprises monitoring the latency time periods of at least two of said available of communication carriers, wherein at least one of said monitored communication carriers is selected which fulfills said latency time period requirement.

By monitoring the latency periods of at least two of said plurality of communication carriers it can always be determined if the actually selected communication is still providing latency values that are low enough to provide a satisfying game experience. It may be applicable to monitor only those communication carriers that are principally capable of providing the desired latency values.

That is, the terminal software or hardware is able to monitor, judge and select between different carriers of the same or other mobile communication networks like Bluetooth (BT), wireless local area network (WLAN), Circuit Switched (CS) such as Global System for Mobile communication (GSM), Enhanced Data rates for GSM (EDGE) Enhanced Circuit Switched Data (ECSD), Packet Switched (PS) such as General Packet Radio Service (GPRS), Code Division Multiple Access (CDMA), wideband CDMA (WCDMA) or other. The selection of a carrier can, beside the required latency of the carrier, (peer to peer or peer to server) also depend on the needed bandwidth of the terminal application. Once the terminal has selected a carrier it is seamlessly monitored for other available carriers. Whether one of the observed carriers has better latency performances as the carrier actually in use the connection is handed over to the new carrier if requested from the game running on the terminal.

In another example embodiment of the method of the present invention said selection of at least one of said determined communication carriers is performed according to a pre-stored table, wherein said pre-stored table is associating said latency time period requirements to possible communication carriers. The table can be a pre-stored table that is incorporated in a mobile device. This embodiment has the advantage that the table can only comprise the communication carriers that are actually implemented in the mobile device. The table can be a pre-stored table that is incorporated in a game module or in a game application. The table that is a part of an application can be embodied as a simple list comprising only the communication carriers in a decreasing succession of operability. This list may also be user configurable.

In one example embodiment of the present invention the said communication carrier with the shortest latency time period is selected.

In another example embodiment of the present invention said selection of one of said communication carriers fulfilling said latency time period requirement is performed in accordance with an additional selection rule. That is, if e.g. two communication carriers have the same latency time period the above system can not decide which carrier is to be selected. In case that the carrier actually in use provides a latency that is equalized by the latency of another carrier, a change of the carrier does not provide any advantages, and therefore, should not be performed. If the online game application is started, and there is no additional selection rule provided there is no way to decide which of the carriers is to be selected.

Especially in the case of online games the requirements for bandwidth and latency of a transmission depend strongly on the type of game actually used. Some game applications can require high bandwidths, but the requirements for the latency may be low. Other game applications may only be played with low latencies while e.g. required bandwidth is low.

Action games that are based on the speed of reaction of a user may be played with low bandwidths, when e.g. only the moves (position changes of a vehicle or a virtual player) of the participants are to be transferred, but not the whole data stream for the display. In a race simulation a latency time of more than e.g. a tenth second results in degraded playing experience. Other games such as brain-teasers, e.g. chess, checker, board games and turn based games can be played with much longer latency times in the data transmission.

In another example embodiment of the present invention said method further comprises receiving said latency time period requirement via said connection from one of said at least one remotely located devices, wherein said latency time period requirement represents an allowable latency range.

By receiving the latency time period requirement from a remote game server or game device, it is possible to adapt the own latency time period requirements to achieve a superior overall performance. If e.g. two or more players participate in a game running on a game server, similar latency periods should be achieved to ensure fairness. That is, the data transfer times between all participating devices should substantially be equal to prevent a player with a high latency data connection being at a disadvantage.

In the case that two players play directly against each other via e.g. local wireless connection, and the game software is running on both devices the lowest overall latency should be achieved, as any effects of differences of the latency would level each other out in both directions.

By using latency ranges delimited by an upper and lower limits of latency as the latency time period requirement it is possible to prevent the selection of an over-sophisticated transmission carrier.

In another embodiment of the present invention the method further comprises adding a latency adjustment delay to the data communication. This enables a kind of terminal device based latency fairness policy by removing latency differences by retarding the data reception and/or data transmission. This latency fairness on the other hand increases the latency time period requirement to the selected carrier, as even with an added delay a maximum latency is not to be exceeded in e.g. an action game. The latency adjustment delay can also be implemented in a game server.

Thereby, none of the devices connected to the server can provide a game information to a player earlier, i.e. the present invention provides a kind of latency based game synchronization. It is possible to measure the latency time by signal runtime analysis. This analysis can be performed by the mobile user devices or e.g. by a game server device. It is also possible to measure the runtime and latency times and transfer these times (actual latencies) to all connected devices. It is also possible to transfer all measured or employed latency fairness delays, to prevent that all devices use such a delay. It is desirable if the device with the highest actual latency period for game data transmission does not use a latency fairness delay, slowing down the data transfer unnecessarily. It is therefore desirable to also transfer the actually employed latency values to the game server or to every connected mobile gaming device.

In another example embodiment of the present invention said additional selection rule selects said communication carrier according to the connection costs. This embodiment of the invention considers besides the requirements of the game application also the wishes of a user such as data transfer charges, personal sympathies for a specific carrier, or wishes of the communication carriers (e.g. network providers) and the like. It is usually the case that the network providers strive to achieve profit by providing the data transfer.

It is also to be mentioned that the time variations of the latency are also to be taken into account. This also applicable to the data signal quality such as indicated by jitters and the like.

In yet another example embodiment of the present invention said additional selection rule selects said communication carrier according to the bandwidth. Thereby it is estimated that the higher bandwidth can also be advantageous for the game execution.

In another example embodiment of the present invention, said additional selection rule selects said communication carrier according to the energy consumption required for the communication via said wireless online connection provided by said online carrier. Especially in a mobile environment the energy consumption of non-vital systems is to be reduced to a minimum with regard to runtime and standby times.

In another example embodiment said latency time period requirement for said executed online game application is received in form of game categories. By using game categories the storage requirements and the selection of the communication carriers can be simplified. In this case the best data communication channels and the best data channels are selected according to a game category and not according to the individual data of a specific game. By using categorized latency time period requirements, it is possible to use pre-selected communication carrier groups to be monitored. Thereby it can be achieved that virtual board games can not access high-speed and low latency communication carriers, as these are not monitored. That is, this embodiment is using a latency range to select a communication carrier and does not simply select the carrier with the lowest latency, but the carrier with the lowest suitable latency. It is also possible to select the communication carrier according to the actual costs and attainability of the carrier.

According to another aspect of the invention a computer program product for carrying out the method adapting the configurations of an application of a mobile terminal device to an available data connection is provided, comprising program code means stored on a computer readable medium for carrying out the methods of the preceding description when said program product is run on a mobile terminal device. It may be noted that the expression “computer program product stored on a computer readable medium” also comprises the possibility that the computer program is downloadable from a server where it is stored on a computer readable medium.

According to another aspect of the present invention a mobile terminal device is provided which is capable of executing different wirelessly executable online game applications by exchanging communication data with at least one remotely located device using any of a plurality of distinct communication carriers. The mobile terminal device comprises a processing unit, at least two radio interfaces, latency time period requirement receiving means, a first and a second determining component, and communication carrier selector.

The processing unit is capable of executing online game applications. Each of said at least two radio interfaces, is connected to said processing unit, and is capable of accessing at least one data connection carrier. In case of Bluetooth (BT) this carrier would be represented by another BT device, and in the case of cellular communication the carrier can be represented by a cellular phone company, a certain data transfer mode like GPRS or the like. By using two different radio interfaces it is possible to access different communication carriers simultaneously in different frequency ranges. It is also possible to simultaneously monitor a number of communication carriers and to simultaneously communicate game data via another communication carrier. By using two different radio interfaces a fully seamless change of the communication carrier is possible. It is also possible to use components in the both radio interfaces that are used commonly by at least two radio interfaces.

The receiving means is provided for determining a latency time period requirement of an executed game application. The receiving means or component is connected to said processing unit, and can receive a latency time period requirement of the executed game application. The receiving means can also actively retrieve or determine the latency time period requirements of an executed game application.

The first determining component or determination circuit is provided for determining available communication carriers for wireless communication. The determining component is connected to said receiving means. The determining component simply determines all or only a number of available communication carriers; this component can in turn try to connect to any kind of wireless communication service that is accessible by the mobile device, i.e. a kind of service discovery component.

The second determining component is configured to determine which of the available communication carriers is appropriate for the intended wireless communication based on latency time requirements of the executed wireless online game application. The second determining means or circuit is connected to said receiving means.

It is to be noted that the first and the second determining components can be connected to each other, and that the determination components may be operated dependently. That is, the second determination component may determine a number of appropriate communication carriers first and the first determination component may only search for appropriate communication carriers, or vice versa.

The communication carrier selector is connected to said second determining component or second determining circuit to said at least two radio interfaces and is configured to select at least one of said appropriate and available communication carriers fulfilling said latency time period requirement.

In one example embodiment of the present invention said mobile terminal device further comprises a latency time period monitor. The latency time monitor is connected to said data radio interfaces, and is configured to obtain and monitor the latency time periods of at least two of said plurality of communication carriers. In this embodiment said communication carrier selector configured to select at least one of said monitored (available and appropriate) communication carriers fulfilling said latency time period requirement.

The latency monitor is connected to said data exchanging means. The latency monitor is configured to monitor the latency of at least two of said plurality of communication carriers. This can be implemented by a circuitry that selects each of a number of possible or (pre-selected) communication carriers to determine the actual latency period of each of said carriers. The implementation can be performed analogously to e.g. the frequency selection of radio data system (RDS) radios. The monitoring means monitors the latency of the communication carriers provided by said communication carriers. It is possible that the monitoring is performed by periodically dispatching runtime messages to determine the actual latency values. This kind of message based latency monitoring is associated with an actual data transfer and therefore can be a chargeable service. It is possible that the communication carriers periodically broadcast or page their actual averaged latency times periodically, without charging. This implementation would not be able to page the actual latency period for a certain data communication, but would only be able to provide average values, as the carrier can not determine the actually desired connection and data transmission path. This implementation may also lead to customer oscillation, wherein e.g. a great number of customers with the same latency optimization program start simultaneously changing the communication carrier thereby increasing the latency periods of this carrier etc.

The communication carrier selector is connected to said latency monitor and to said at least two radio interfaces and is configured to select at least one of said monitored communication carriers fulfilling said latency time period requirement.

The capability to select more than one communication carrier can enable the use of multi-path communication and data exchange with different reception and transmission rates and even different upload and download bandwidths.

In yet another example embodiment of the present invention said communication carrier selector can access a pre-stored table, associating said latency time period requirements to possible communication carriers, and wherein said selector is configured to select at least one of said determined communication carriers according to said pre-stored table.

In another example embodiment of the present invention said communication carrier selector further comprises an additional selection rule to select at least one of said communication carriers accordingly. In the case of a user-selectable additional rule said parameters such as personal preferences of specific carriers, hysteresis values for latency advantages to prevent communication carrier hopping if only a slight latency advantage are determined. It is also possible to implement a timer element and a rule that the latency of the other communication carrier has to be lower for a predetermined period to select the other carrier as the new one.

In yet another example embodiment of the present invention said communication carrier selector selects said carrier according to the energy consumption required for the data communication of said wireless online connection provided by said online carrier. Especially in the case of mobile devices and mobile gaming a low energy consumption data connection can contribute to a longer effective playing time.

In another example embodiment of the present invention said communication carrier selector selects said carrier according to an allowable latency range. This feature can restrict the use of low latency radio connections only for game applications that can be played with high latency periods only.

In yet another example embodiment of the present invention said mobile gaming device further comprises an adjustable delay component connected between said processing unit and said at least two data exchanging means, and that is connected to said latency monitor. The delay component can be used to controllably add a defined latency to the latency of a communication carrier. This enables the device to provide defined latency even in case of jitters and varying latency periods. It is also possible to use the “extra delay” to provide a defined game-user interface with defined reaction times even under varying communication latency conditions. In a more sophisticated approach the actual delay period may be transferred to other participating users/devices to ensure that all users are playing with the same latency. It is also possible to use a kind of normalized latency that is sent to all participating devices to indicate “common” standard latency to be used in a fair game.

In one example embodiment said mobile game terminal device further comprises a cellular telephone. That is, the terminal can be used besides game application execution for cellular voice telephony.

In the following, the invention will be described in detail by referring to the enclosed drawings in which:

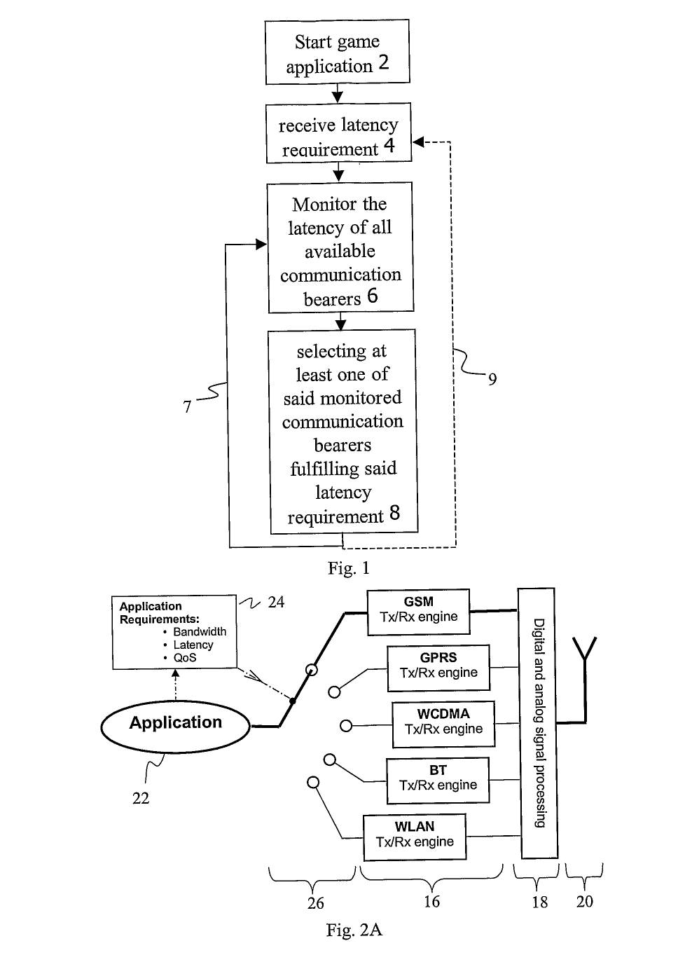

FIG. 1 is a flowchart of a method for selecting a carrier for wireless communication of a mobile electronic game terminal according to one aspect of the present invention,

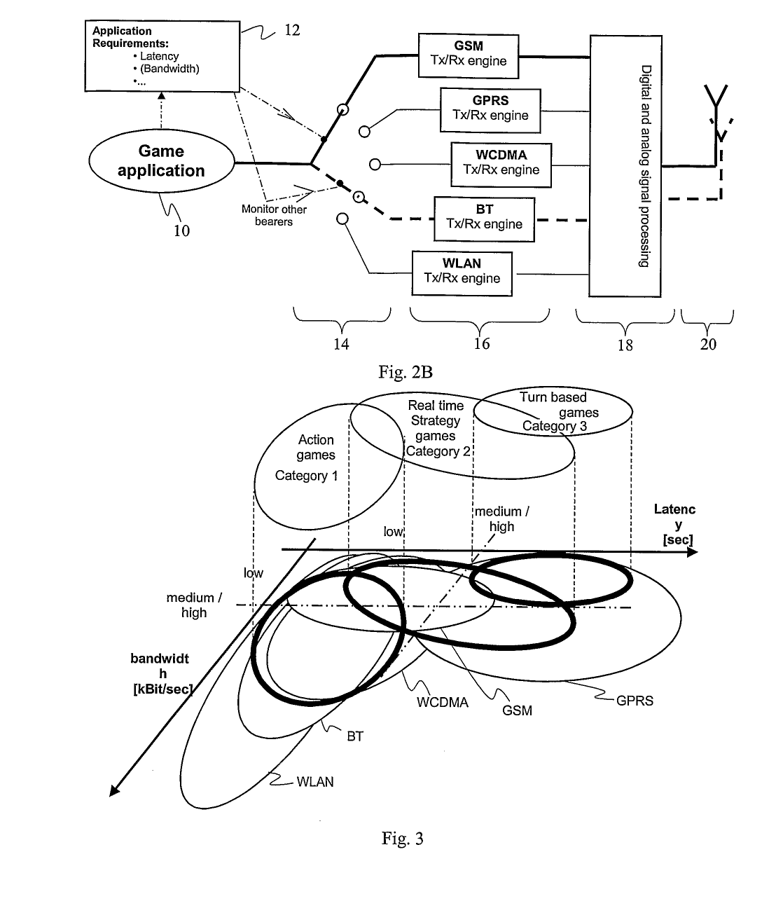

FIGS. 2A and 2B are examples of a mobile game terminal device, according to another aspect of the present invention,

FIG. 3 illustrates schematically the requirements of different game applications and the transmission properties of different communication carriers, and

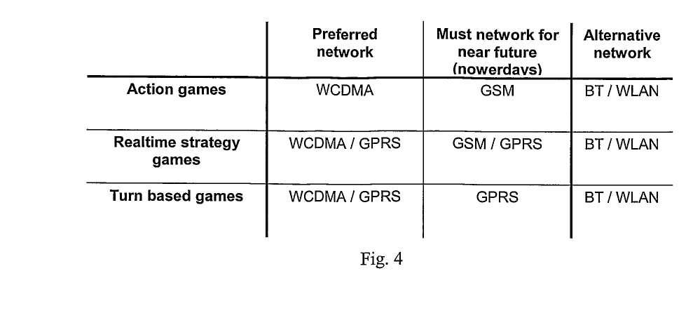

FIG. 4 illustrates an exemplary communication carrier selection table.

FIG. 1 represents an example of a method for selecting a carrier for wireless communication of a mobile electronic terminal device according to the present invention. The mobile gaming terminal device is capable of executing different wirelessly executable online game applications by exchanging communication data with at least one remotely located device using any of a plurality of distinct communication carriers. The method starts with the starting 2 or the execution of a wireless online game application. That is, the game application can be played via a wireless connection with another game device (peer to peer) or via a (partially) wireless connection with a game server (peer to server). The invention can be played or started with a default communication carrier or with the carrier that has been selected the last time the game has been used.

After the start of the wireless online game application a latency time period requirement is received 4. The latency time period requirement can be received from the application or for example from a peer device or from a games server. It is also possible to obtain the latency time period requirement by querying the storage the game application is provided on.

During the game execution the latency of at least two of said plurality of communication carriers is permanently or periodically monitored 6. Depending on the actual required latency values required by the game application the device can monitor all communication carriers the device is configured to communicate with. It is also possible to monitor only those communication carriers that may provide the requested latency in the data communication.

Then, at least one of said monitored communication carriers that fulfills said latency time period requirement for the data transfer for said executed online game is selected to provide the data communication to a peer game device or a games server.

That is, this invention addresses the problem to minimize the latency between peer to peer or peer to server wireless communications in the case of game applications. The invention proposes a special type of future terminal radio game hardware and control logic. Based on the proposed hardware the terminal will be able to monitor and select carriers of different wireless networks (like, BT, WLAN, CSD (GSM), PSD (GPRS, WCDMA, CDMA)) with different latency and bandwidth requirements requested by the game application running on the terminal.

FIG. 2A depicts an example of a mobile game terminal device, according to another aspect of the present invention. The mobile terminal device is capable of executing different wirelessly executable online game applications on a processing unit 22. The execution of the game application comprises the exchange of game communication data with at least one remotely located device (not shown) using any of a plurality of distinct communication carriers (not shown).

The processing unit is connected to receiving means (not shown) for obtaining a latency time period requirement of a game application running on said processing unit 22.

In FIGS. 2A and 2B there are five radio interfaces 16, 18, and 20 depicted, one for GSM, GPRS, WCDMA, Bluetooth and Wireless LAN, respectively. The radio interfaces each comprise a specific component 16 and a common signal processing circuit 18 being connected to a number of antennas 20.

Each of the radio interfaces 16, 18, 20 can be connected via a communication carrier selector switch 26 that is operated by carrier control component 24 comprising the first and second determining components and the communication carrier selector of the claims. In the carrier control component 24 there is the first determining component provided to determine available communication carriers. The carrier control component 24 also comprises the second determining component to determine appropriate communication carriers. The carrier control component 24 also comprises the carrier selector to select one of appropriate and available communication carriers if more than one communication carrier is determined to be available and appropriate.

In the depicted embodiment there is only a single line from the carrier selector 14 to the processing unit 22. In this case the data transmissions and the signals for determining the availability of communication carrier signals may be transferred in a time divisional access mode. It is also possible to employ two connections from the carrier selector 14 to the processing unit 22. In this case different communication carriers can be used for data uplink and data downlink of the same data transmissions.

FIG. 2B depicts an example of a mobile game terminal device, according to another aspect of the present invention. The mobile terminal device is capable of executing different wirelessly executable online game applications on a processing unit 10. The execution of the game application comprises the exchange of game communication data with at least one remotely located device (not shown) using any of a plurality of distinct communication carriers (not shown).

The processing unit is connected to receiving means (not shown) for obtaining a latency time period requirement of a game application running on said processing unit 10.

Each of the radio interfaces 16, 18, 20 can be connected via a communication carrier selector 14 that is operated by a latency monitor 12 and the processing unit 10. In the depicted embodiment the processing unit 10 forwards the data received from the radio interface to the latency monitor 12 for evaluation. The latency monitor 12 operates the carrier selector 14 to selectively connect the processing unit with at least one of the radio interfaces 16, 18, 20.

In the depicted embodiment there is only a single line from the carrier selector 14 to the processing unit 10. In this case the data transmissions and the latency monitoring signals may be transferred in a time divisional access mode. It is also possible to employ two connections from the carrier selector 14 to the processing unit 10. In this case the game data transmissions and the latency monitoring signals may be transferred simultaneously.

The latency monitor 12 in connection with the carrier selector 14 evaluate and select the communication carrier with the lowest monitored latency time fulfilling said latency time period requirement.

For the sake of clarity, in FIGS. 2A and 2B the components like displays, memory devices and modules and user input components have been omitted.

FIG. 3 illustrates schematically the requirements of different game applications and the transmission properties of different communication carriers. Furthermore this figure points out the relation between different types of games and existing networks. Different types of games require different latencies and bandwidth for an adequate playing experience. For example turn based games such as board games, dice games can be played with low bandwidths and with high latencies. Games of the successive turn type can form a “category-three” of online games with low bandwidth and latency time period requirements.

A second category can comprise real time strategy games without fast reaction time components. This category of games demands a wider range of higher bandwidth and latency. For example in a dialogue sequence a long delay for an answer of a virtual character can dampen the user experience. Especially the category-two games can be played with a large number of different communication carriers, as category-two games can change the latency and bandwidth requirements during the game. Thus, the present invention may be utilized to change the communication carrier simultaneously with the changes of the latency time period requirements. A change of the latency and bandwidth requirements may be hidden in a video sequence. A change of the communication carrier can be performed seamlessly and instantaneously as the device already has pre-monitored the possible communication carriers.

In case of action and reaction games such as vehicle and plane races, martial arts and combat games with a wider range of bandwidth requirements only short latencies are acceptable, as the period for reacting to an event is very short. The allowable latencies have to be considerably shorter than the average speed of reaction of a player. Especially category-one games profit from the present invention, as the lowest possible latency can be achieved in the game play.

In FIG. 3, the oval areas indicated in thin lines schematically represent the different communication carrier techniques such as Wireless LAN (WLAN), Bluetooth (BT), Wideband Code Division Multiple Access (WCDMA), Global System for Mobile communication (GSM) and General Packet Radio Service (GPRS), as examples for different possible communication carriers.

The oval areas indicated in thick lines schematically represent the different requirements of the different possible game categories. The overlapping of the different oval areas indicate that the category-three games can best be played using GPRS, and a GSM connection may be an adequate alternative if high bandwidth and low latency is required.

Category-two games with a wide range of possible bandwidth and latency time period requirement can be used with all of the communication carriers. This means that category-two games can considerably benefit from the present invention. The gaming device can choose one of the five different communication carriers, as the probability that a carrier can be found that better fits the requirements of a category-two game is large.

The category-one games can benefit from the present invention, as a low latency data communication is essential for a rich game experience.

FIG. 4 illustrates an exemplary communication carrier selection table, as it may be derived from FIG. 3. In the left column there are listed the different categories of games, i.e. action games, realtime strategy games and turn based games. The first column indicates the preferred access bearer or communication carrier, which is Wideband Code Divisional Multipe Access (WCDMA) for all types of games and this allows also General Packet Radio Service (GPRS) for realtime strategy games and turn based games. The second column relates to the wireless transmission technology actually available. Today, action games can only be played via Global System for Mobile Communication, while turn based games can best be played via GPRS. Today realtime strategy games may be played via GSM or via GPRS. IT is also possible to play these games vial local networks such as Bluetooth (BT) and Wireless Local Area Networks (WLAN), as an alternative for provider based communication networks. When employing this table in a mobile terminal the carrier of the left column would be selected preferably, while the one of the communication carriers of the middle column would be selected if one of the communication carriers of the left column is not available.

With the present invention a device (or game) can select carriers out of different types of networks to fulfil the latency time period requirements requested by the terminal application (e.g. action games that require transmission latencies of about 100 msec and less, while GPRS networks e.g. used by the Nokia N-Gage game deck devices are not able to fulfil these latencies).

Especially mobile gaming devices such as the successor devices of Nokia N-Gage will benefit from the present invention. Games that actually can not be played over cellular networks can be played in the future. The mobility of online gaming devices is then completed, when all games and categories of games can be played everywhere.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently, various options of implementing the invention as determined by the claims, including equivalent implementations, also belong to the scope of the invention.

1. A method for selecting a carrier for wireless communication of a mobile electronic terminal device capable of executing wireless online game applications by exchanging communication data with at least one remotely located device by using any of a plurality of distinct communication carriers, comprising the steps of:
executing a wireless online game application,
receiving a latency time period requirement for the data transfer of said executed online game application, wherein said latency time period represents the time period required to transfer game data via said online communication to said at least one remotely located device;
determining communication carriers available for wireless communication;
determining which of the available communication carriers is/are appropriate for the intended wireless communication based on latency time requirements of the executed wireless online game application
selecting at least one of said determined communication carriers which is determined to be appropriate for the wireless game application.

2. Method according to claim 1, further comprising:
monitoring the latency time periods of at least two of said available of communication carriers, wherein at least one of said monitored communication carriers is selected which fulfills said latency time period requirement.

3. Method according to claim 1, wherein said selection of at least one of said determined communication carriers is performed according to a pre-stored table, wherein said pre-stored table is associating said latency time period requirements to possible communication carriers.

4. Method according to claim 1, wherein the communication carrier with the shortest latency time period is selected.

5. Method according to claim 1, wherein said selection of one of said communication carriers fulfilling said latency time period requirement is performed in accordance with an additional selection rule.

6. Method according to claim 1, further comprising receiving said latency time period requirement from one of said at least one remotely located devices, and wherein said latency time period requirement represents a latency time period range.

7. Method according to claim 5, further comprising adding a latency time period adjustment delay to the data communication.

8. Method according to claim 5, wherein said additional selection rule selects said communication carrier according to the connection costs.

9. Method according to claim 5, wherein said additional selection rule selects said communication carrier according to the bandwidth.

10. Method according to claim 5, wherein said additional selection rule selects said communication carrier according to the energy consumption.

11. Method according to claim 1, wherein said latency time period requirement for said executed online game application is received in form of a game category.

12. Computer program product comprising program code means stored on a computer readable medium for carrying out the method of claim 1 when said program product is run on a computer or network device.

13. Computer program product comprising program code, downloadable from a server for carrying out the method of claim 1 when said program product is run on a computer or network device.

14. Mobile terminal device capable of executing different wirelessly executable online game applications by exchanging communication data with at least one remotely located device using any of a plurality of distinct communication carriers, comprising:
a processing unit capable of executing game applications,
at least two radio interfaces, each capable of accessing at least one data connection carrier, connected to said processing unit,
receiving means for receiving a latency time period requirement for the data transfer of said executed online game application, said receiving means being connected to said processing unit,
a first determining component for determining communication carriers available for wireless communication, wherein said determining component is connected to said receiving means;
a second determining component configured for determining which of the available communication carriers is appropriate for the intended wireless communication based on latency time requirements of the executed wireless online game application, wherein said determining component is connected to said receiving means; and
a communication carrier selector configured to select at least one of said appropriate communication carriers fulfilling said latency time period requirement.

15. Mobile terminal device according to claim 14, further comprising:
a latency time period monitor connected to said data radio interfaces, being configured to obtain and monitor the latency time periods of at least two of said plurality of communication carriers, and
wherein said communication carrier selector is configured to select at least one of said monitored communication carriers fulfilling said latency time period requirement.

16. Mobile terminal device according to claim 14, wherein said communication carrier selector can access a pre-stored table, associating said latency time period requirements to possible communication carriers, and wherein said selector is configured to select at least one of said determined communication carriers according to said pre-stored table.

17. Mobile terminal device according to claim 14, wherein said communication carrier selector further comprises an additional selection rule to select at least one of said communication carriers accordingly.

18. Mobile terminal device according to claim 14, wherein said communication carrier selector selects said carrier according to the energy consumption.

19. Mobile terminal device according to claim 14, wherein said communication carrier selector selects said carrier according to an allowable latency time period range.

20. Mobile terminal device according to claim 14, further comprising an adjustable delay component connected between said processing unit and said at least two radio interfaces, and connected to said latency monitor.

21. Mobile terminal device according to claim 14, further comprising a cellular telephone.
